(19) United States
(12) Patent Application Publication
(10) Pub. No.: US 2018/0362886 A1
(43) Pub. Date: Dec. 20, 2018

(54) DETERGENT FOR EYE GLASSES

(71) Applicant: HON HAI PRECISION INDUSTRY CO., LTD., New Taipei (TW)

(72) Inventor: HSIU-WEN CHIEN, New Taipei (TW)

(21) Appl. No.: 15/653,674

(22) Filed: Jul. 19, 2017

(30) Foreign Application Priority Data
Jun. 20, 2017 (TW) 106120478

(51) Int. Cl. C11D 3/00; C11D 3/37; C11D 3/16; C11D 1/90; C11D 3/20

(52) U.S. Cl. CPC C11D 3/0078; C11D 3/3707; C11D 3/201; C11D 1/90; C11D 3/162

(57) ABSTRACT

A detergent for eye glasses which does not damage an anti-stain coating on the glasses, is disclosed. The detergent comprises a silane mixture with a weight percentage of 23% to 32% and a surfactant with a weight percentage of 68% to 77%, the silane mixture comprises hydrophobic silane compounds and alcohol compounds.

### FIELD

The subject matter relates to a detergent for eye glasses.

### BACKGROUND

Eye glasses are worn by users to correct vision, or for cosmetic or therapeutic reasons. However, stain is often generated on the surface of the eye glasses during use. Thus, a detergent is needed to clean the glasses. However, the detergent may cause damage to an anti-stain layer on the surface of the eye glasses.

### BRIEF DESCRIPTION OF THE DRAWINGS

Implementations of the present technology will now be described, by way of example only, with reference to the attached figure, wherein:

The figure is a diagram of a silylation reaction between hydrophobic silane compounds in a detergent of the exemplary embodiment and a surface of eye glasses.

FIG. 1A is a diagram of a hydrolysis reaction of hydrophobic silane compounds in a detergent.

FIG. 1B is a diagram of a condensation reaction between Si—OH groups and a surface of eye glasses of FIG. 1A.

FIG. 1C is a diagram of the Si—OH groups reacting with the hydroxyl groups of the compound A-OH on the surface of the eye glasses to form hydrogen bonds.

FIG. 1D is a diagram of the hydrogen bonds being dehydrated to form covalent bonds which are connected to the eye glasses when heated, and to form an anti-fingerprint layer.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein can be practiced without these specific details.

In other instances, methods, procedures, and components have not been described in detail so as not to obscure the related relevant feature being described. Also, the description is not to be considered as limiting the scope of the exemplary embodiments described herein. The drawings are not necessarily to scale and the proportions of certain parts may be exaggerated to better illustrate details and features of the present disclosure.

One definition that applies throughout this disclosure will now be presented.

The term “substantially” is defined to be essentially conforming to the particular dimension, shape, or other feature that the term modifies, such that the component need not be exact. For example, “substantially rectangular” means that the object resembles a rectangle, but can have one or more deviations from a true rectangle.

The term “comprising,” when utilized, means “including, but not necessarily limited to”; it specifically indicates open-ended inclusion or membership in the so-described combination, assembly, series, and the like.

A detergent of the exemplary embodiment can be used to remove stains on eye glasses.

The detergent comprises a silane mixture with a weight percentage of 23% to 32% and a surfactant with a weight percentage of 68% to 77%. The silane mixture comprises hydrophobic silane compounds and alcohol compounds. The eye glasses may be spectacle glasses or contact lenses.

The hydrophobic silane compound (chemical formula: RSi(OMe)₃) and a surface of the eye glasses undergo a silylation reaction to form an anti-fingerprint layer on the surface of eye glasses.

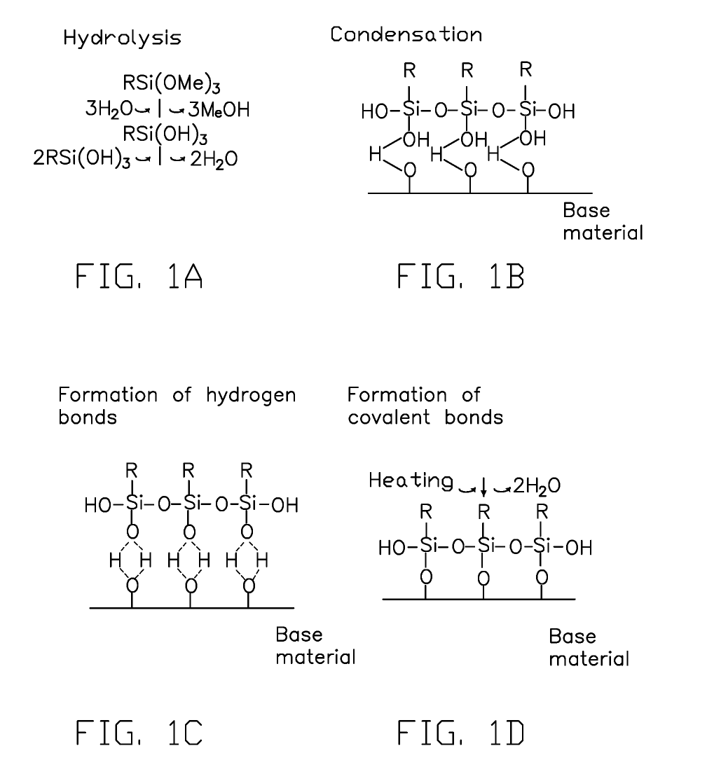

Referring to FIGS. 1A through 1D, the silylation reaction includes four stages, which are a hydrolysis stage (FIG. 1A), a condensation stage (FIG. 1B), a hydrogen bond forming stage (FIG. 1C), and a covalent bond forming stage (FIG. 1D).

In FIG. 1A, the hydrolysis stage is: the Si—(OMe)₃ bonds of the hydrophobic silane compound RSi(OMe)₃ hydrolyzes to generate Si—OH groups.

In FIG. 1B, the condensation stage is: the Si—OH groups being dehydrated and condensed to produce a siloxane oligomer R₃Si₃O₂(OH)₅.

In FIG. 1C, the hydrogen bonds forming stage is: the Si—OH groups of the R₃Si₃O₂(OH)₅ reacting with the hydroxyl groups of the compound A-OH on the surface of the eye glasses to form hydrogen bonds.

In FIG. 1D, the covalent bonds forming stage is: the hydrogen bonds being dehydrated to form covalent bonds which are connected to the eye glasses when heated, and to form an anti-fingerprint layer comprising R₃Si₃O₂(OH)₂O₃A₃.

The alcohol compounds disperse the hydrophobic silane compounds, so that the hydrophobic silane compounds are evenly dispersed in the silane mixture. The ratio of the hydrophobic silane compounds with respect to the alcohol compound can be changed as needed, so long as the hydrophobic silane compounds can be dispersed in the silane mixture.

The silane compound can be selected from a group consisting of perfluoropolyether trimethoxysilane and nonafluorohexyl trimethoxysilane, and the combination thereof. The alcoholic compound can be selected from a group consisting of methanol and ethanol, and the combination thereof. In at least one exemplary embodiment, the alcohol compound is ethanol.

The surfactant can be selected from a group consisting of cocamidopropyl betaine, glycerol, alkyl-glucoside, orange essential oil, and grapefruit seed extract, and any combination thereof. In the exemplary embodiment, the surfactant also comprises an additive. The additive can be sodium chloride solution, which maintains the ionic balance in the detergent.

The detergent can be prepared by mixing the above components and stirring.

### EXAMPLE 1

The detergent comprises a silane mixture with a weight percentage of 23% and a surfactant with a weight percentage of 77%. The silane mixture comprises a perfluoropolyether trimethoxysilane with a weight percentage of 1% and ethanol with a weight percentage of 99%. The surfactant comprises cocamidopropyl betaine of 88 mL, glycerin of 30 mL, and sodium chloride solution having a concentration of 0.00533 g/mL.

### EXAMPLE 2

The detergent comprises a silane mixture with a weight percentage of 32% and a surfactant with a weight percentage of 68%. The silane mixture comprises a nonafluorohexyl trimethoxysilane with a weight percentage of 0.7% and ethanol with a weight percentage of 99.3%. The surfactant comprises 640 mL water, 300 mL alkyl-glucoside, 50 mL orange essential oil, and 10 g grapefruit seed extract.

The hydrophobic silane compounds and the surface of the eye glasses undergo a silylation reaction to form an anti-fingerprint layer on the surface of the eye glasses, to protect the anti-stain layer of the eye lenses. Thus, the detergent can remove the stain on the surface of the ophthalmic lens without causing damage to the anti-stain layer.

The embodiment shown and described above is only an example. Many details are often found in the art such as the other features of the street lamp. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure up to, and including the full extent established by the broad general meaning of the terms used in the claims. It will therefore be appreciated that the embodiments described above may be modified within the scope of the claims.

1. A detergent for eye glasses, the detergent comprising:
a silane mixture with a weight percentage of 23% to 32%; and
a surfactant composition with a weight percentage of 68% to 77%, the silane mixture comprising hydrophobic silane compounds and alcohol compounds, wherein the hydrophobic silane compounds are selected from a group consisting of perfluoropolyether trimethoxysilane and nonafluorohexyl trimethoxysilane, and the combination thereof.

2. (canceled)

3. The detergent of claim 1, wherein the alcoholic compounds are selected from a group consisting of methanol and ethanol, and the combination thereof.

4. The detergent of claim 1, wherein the surfactant composition comprises a surfactant, the surfactant is selected a group consisting of cocamidopropyl betaine, alkyl glucoside, and any combination thereof.

5. The detergent of claim 1, the surfactant composition further comprising an additive.

6. The detergent of claim 5, wherein the additive is a sodium chloride solution.

7. The detergent of claim 1, wherein the detergent comprises the silane mixture with a weight percentage of 32% and the surfactant composition with a weight percentage of 68%.

8. The detergent of claim 7, wherein the silane mixture comprises a nonafluorohexyl trimethoxysilane with a weight percentage of 0.7% and ethanol with a weight percentage of 99.3%.

9. The detergent of claim 7, wherein the surfactant composition comprises 640 mL water, 300 mL alkyl-glucoside, 50 mL orange essential oil, and 10 g grapefruit seed extract.

10. The detergent of claim 1, wherein the detergent comprises the silane mixture with a weight percentage of 23% and the surfactant composition with a weight percentage of 77%.

11. The detergent of claim 10, wherein the silane mixture comprises a perfluoropolyether trimethoxysilane with a weight percentage of 1% and ethanol with a weight percentage of 99%.

12. The detergent of claim 10, The detergent of claim 10, wherein the surfactant composition comprises cocamidopropyl betaine of 88 mL, glycerin of 30 mL, and sodium chloride solution having a concentration of 0.00533 g/mL.
